(19) United States
(12) Patent Application Publication
(10) Pub. No.: US 2012/0303827 A1
(43) Pub. Date: Nov. 29, 2012

(54) Location Based Access Control

(75) Inventors: Eugene (John) NEYSTADT, Kfar-Saba (IL); Daniel ALON, Tel Mond (IL); Daniel ROSE, Modiin (IL); Elan LEVY, Tel Aviv (IL)

(73) Assignee: MICROSOFT CORPORATION, Redmond, WA (US)

(21) Appl. No.: 13/114,044

(22) Filed: May 24, 2011

(51) Int. Cl. G06F 15/16

(52) U.S. Cl. 709/229

(57) ABSTRACT

A policy enforcement system may use device location as a parameter for granting or denying access to a resource. An access policy may include location parameters that may permit or deny access to the resource based on the physical location of the device. In some cases, the location may be authenticated by a server that may verify the device's location. The access policy may grant or deny full or partial access to the resource, which may be a data resource, such as a file, database, URL, or other information, an application resource, or a physical resource such as a network or a peripheral device. The policy enforcement system may use the device location for regulatory compliance, restricting access to sensitive information, or as a primary or secondary condition for limiting access to a resource.

### BACKGROUND

Many security systems include policies that are evaluated to permit or deny access to various resources. Such policies may, for example, include a minimum set of device characteristics or user characteristics that may be allowed access to a resource. In one such example, a user who is authenticated and has a device that has operational antivirus software may be permitted access to a corporate network.

### SUMMARY

A policy enforcement system may use device location as a parameter for granting or denying access to a resource. An access policy may include location parameters that may permit or deny access to the resource based on the physical location of the device. In some cases, the location may be authenticated by a server that may verify the device's location. The access policy may grant or deny full or partial access to the resource, which may be a data resource, such as a file, database, URL, or other information, an application resource, or a physical resource such as a network or a peripheral device. The policy enforcement system may use the device location for regulatory compliance, restricting access to sensitive information, or as a primary or secondary condition for limiting access to a resource.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system with an access control system.

FIG. 2 is a flowchart of an embodiment showing a method for access control.

FIG. 3 is a timeline diagram of a first embodiment showing a sequence for granting access to a resource.

FIG. 4 is a timeline diagram of a second embodiment showing a sequence for granting access to a resource.

FIG. 5 is a timeline diagram of a third embodiment showing a sequence for granting access to a resource.

### DETAILED DESCRIPTION

A policy enforcement system may use device location as one parameter in granting or denying access to a resource. The device location may be a self-reported location or may be verified by a third party, and may be one parameter by which access may be permitted.

Device location may be used in several use scenarios. In one use scenario, certain applications, functions, or data may be restricted to access by certain municipalities or jurisdictions. For example, certain countries may restrict a specific cryptographic technology from being used inside the country's borders. Access the cryptographic function may be permitted or denied based on a device's location.

In another use scenario, a policy may identify certain geographical locations that are known to be hostile to corporate networks. The policy may include a statement that prohibits any connections from devices located in those geographical locations, regardless if any other criteria for access are met. Such a policy may serve as an extra layer of protection to malicious hackers.

The device location may be used to permit access from only specific locations, such as accessing data only from certain locations. In another use scenario, the physical location of a device may determine whether or not encrypted data may be decrypted and used. In still another use scenario, a data center may accept data from a client that is located within a specific area but deny data from other areas.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

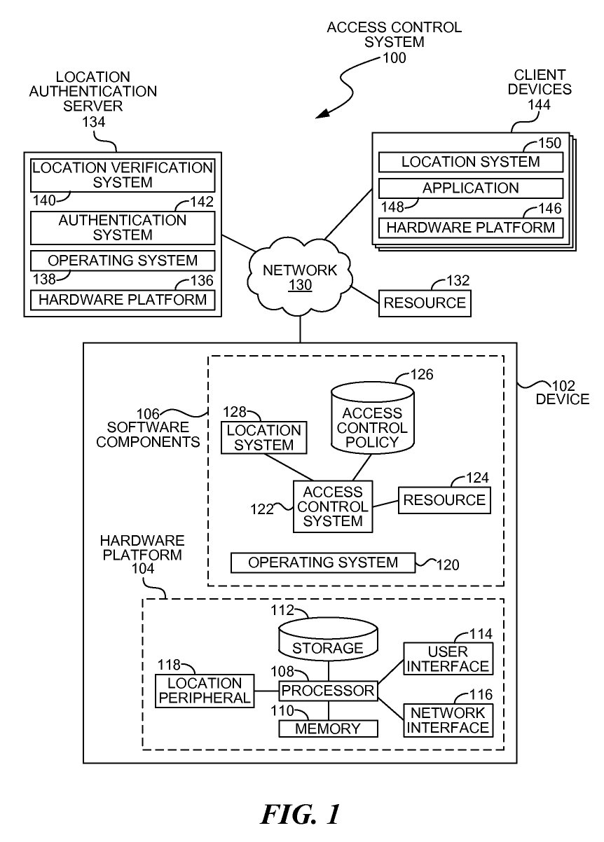

FIG. 1 is a diagram of an embodiment 100, showing a device 102 that may have a location based access control system. Embodiment 100 is an example of a device that may monitor access to a resource, and grant or deny access to the resource based in part on the requesting device's location.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates an access control system that uses a requesting device's location as a factor in determining whether or not to grant access to a resource. The requesting device's location may be verified and authenticated in some embodiments, and the location may be one factor amongst several factors that may be used to permit or deny access to the resource.

An access control system may grant or deny access to a resource. A request may be received for the resource, and a policy may be applied to the request to determine whether or not to grant access. The policy may define conditions for which access may be granted or denied, and one of the conditions may be the location of the requesting device. In some cases, some conditions may be user-based conditions, such as whether a user is authenticated, the user's role or position in a company, or other characteristics. In some cases, some conditions may be device-based conditions, such as whether a device has a certain peripheral device, capability, application, anti-malware, or other settings or configurations. In some cases, some conditions may relate to time of day, day of week, or other factors.

The access control policy may be defined in a positive manner, such as defining the conditions for which access may be granted. Some access control policies may be defined in a negative manner, such as defining the conditions for which access will not be granted. In many embodiments, a single policy may define a large set of rules that define multiple conditions for which access may be granted or denied.

The location of the requesting device may be a factor in granting or denying access in several use scenarios. In many embodiments, an access control policy may have multiple factors that may be evaluated to grant access, such as user role, the device configuration, or other factors. These factors may define who may have access and minimum configuration parameters for a device.

In one use scenario, access to a resource may be permitted only from a designated set of locations. For example, a resource may be encrypted using technology that is illegal to export from a designated country or may contain data that is illegal to export to other countries. In such an example, an access control policy grant access only to those devices located within the designated country and may deny access to those devices outside of the designated country.

In another use scenario, certain locations may be known to be hotbeds of hackers and potentially damaging computer activity. Some resources may forbid any access from these locations, regardless if the requesting device meets all of the other parameters for access.

The location parameter in an access control policy may be defined in any manner. In some cases, the location parameter may be defined as within a certain jurisdiction, such as within a country, state, city, neighborhood, or other boundary. The location parameter may be defined as a distance from a certain point, such as within 100 miles of a company's headquarters or within 50 feet of an access point.

The location information may be obtained through any mechanism that may determine a device's location. In some cases, the location information may have a very high degree of accuracy, such as when the device may be equipped with a Global Positioning System (GPS) receiver or where the device's position may be triangulated with other devices having known positions. Such cases may be able to determine a device location within several feet or even higher degree of accuracy.

In some cases, the location information may be less accurate, such as determining location by receiving wireless transmissions from the device by a receiving having a known location. Such cases may be able to determine a device's location within range of a cellular telephone tower, WiFi access point, or other wireless signal.

Some cases may determine location information that may be derived from a network address, connection point, or other network configuration information. Such cases may determine location with an accuracy of several miles or even hundreds of miles.

In some embodiments, the location information may be determined in whole or in part by information provided by the device itself. For example, a device with an internal GPS receiver may provide location information directly. In another example, a device with a wireless receiver may passively detect a signal or set of signals from other devices to determine a location.

In some embodiments, the location information may be determined by other devices that detect the requesting device. For example, a cellular telephone tower may detect that a device is within range of the tower and may provide location information about the device. In another example, the location of a device may be derived from a network address assigned to the device based on the connection point.

In many embodiments, two or more sources of location information may be used to determine an actual location and to verify the location information. In such embodiments, the trustworthiness of location information may be determined by verifying one location claim against another source for location information. Some such embodiments may use two different mechanisms to determine location, each of which may have a different level of accuracy or precision.

For example, a device may have a GPS receiver that places the device within an accuracy of several feet. A secondary source, such as a WiFi access point, cellular telephone tower, network address, or other source may verify that the location provided by the GPS receiver is within the boundaries determined by the second source. In such embodiments, the secondary source may prevent spoofing by the first location source.

In some embodiments, an access control policy may accord different access permissions based on the location information. For example, a device that requests permission from a location within a friendly country may be granted a higher level of access to a resource than another device that requests permission from a hostile country or one known to have many hackers.

In some such embodiments, the device may be granted the same level of access to the resource, but a higher or lower degree of monitoring the activity by the device may be applied. For example, any access from a hostile country may have a complete log of all activity so that any malfeasance may be identified and corrected.

The level of precision of location information may be used as a factor for granting or denying access. For example, a policy may grant access permission for a low level of access for a device that uses a low precision mechanism for location information, but may grant a higher level of access for a device with high precision location information.

The system of embodiment 100 is illustrated as being contained in a single device 102. The device 102 may have a hardware platform 104 and software components 106.

The device 102 may represent a server computer, dedicated gateway device, or other type of computing system that provides access control. In some embodiments, however, the device 102 may be any type of computing device, such as a personal computer, game console, cellular telephone, netbook computer, or other computing device.

The hardware components 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware components 104 may also include a network interface 114. The network interface 114 may include hardwired and wireless interfaces through which the device 102 may communicate with other devices.

The hardware components 104 may further include a location peripheral 118. The location peripheral 118 may be a GPS receiver or other device that may determine a location for the device. In some embodiments, the location peripheral 118 may have a receiver, such as a WiFi receiver, cellular telephone receiver, or other receiver from which location information may be derived.

The software components 106 may include an operating system 120 on which various applications may execute.

The device 102 may have an access control system 122 that may grant or deny access to a resource 124. Resource 124 may be located within the device 102 or within the control of the device 102. Examples of such a resource may include a data resource, such as a local database or file, an application executing on the device 102, or a peripheral device attached to device 102.

In other embodiments, the access control system 122 may provide access control to a remote resource 132. Some such embodiments may deploy the device 102 as a gateway or other device that receives requests from various devices and grants or denies access to the remote resource 132. In other embodiments, the access control system 120 may be located on a local device and may grant or deny access for the device 102 to the remote resource 132.

The access control system 120 may analyze a request for access to a resource by applying an access control policy 126 against the request. In some embodiments, the access control system 120 may receive a request that contains all of the information that may be analyzed. In other embodiments, a request may be received, then the access control system 120 may gather information so that the access control policy 126 may be analyzed. In such embodiments, the access control system 120 may query the requesting device, a third party, or other source of information so that the access control policy 126 may be analyzed.

The access control system 120 may use information provided by a location system 128 in assessing the access control policy 126. The location system 128 may attempt to determine a location for a requesting device, which may be one of the client devices 144. The location system 128 may determine the location of a client device 144 by querying the client device 144 for its location, querying another device that may contain location information for the client device 144, or by some other mechanism.

The client devices 144 may be any type of device that has a hardware platform 146 on which various applications 148 may operate. The client device 144 may be a server computer, desktop computer, game console, or portable computer such as a netbook or laptop computer. The client device 144 may be a portable device such as a portable scanner, personal digital assistant, cellular telephone, satellite telephone, or any other device.

The client device 144 may have a location system 150 that may determine a location for the client device 144. The location system 150 may be, for example, a GPS receiver or other mechanism by which the client device 144 may determine its location.

The location system 128 may operate in conjunction with or may verify a location system 150 on the client device 144.

In some embodiments, a location authentication server 134 may authenticate the location information provided by the client device 144. The location authentication server 134 may receive location information from a client device 144 and authenticate the location information. After authentication, a token may be created that contains the location information. The token may be digitally signed by the location authentication server 134 and may be passed to the access control system 122 in order to allow access to a resource.

In some embodiments, claim based access control may be performed where the claim is a location. Such a claim may be digitally signed by a secure token service may be consumed by various resources.

The location authentication server 134 may have a hardware platform 136 that may contain a processor and other components similar to the hardware platform 104, as well as an operating system 138 and various applications.

One of the applications may be a location verification system 140. The location verification system 140 may verify that location of a client device 144. In some embodiments, the location verification system 140 may verify the location by comparing a reported location with other location information sources to determine if the reported location is valid. In such an embodiment, a client device 144 may report a location using its location system 150. The location verification system 140 may then attempt to determine a location using a secondary source, such as the network address of the client device 144, a signal received from a wireless access point or cellular telephony tower, or other source. When the reported location and the secondary location information are similar, the reported location may be authenticated.

In some embodiments, the location verification system 140 may verify a client device's reported location by verifying that the client device is functioning properly. Such a verification may or may not be performed without checking the location information from a secondary source.

The location verification system 140 may determine that a client device 144 is functioning properly by comparing signatures of applications, operating systems, or other software that are executing on the client device 144 with an expected signature of the software. For example, a signature of an operating system may be read from the boot record of a data storage device attached to the client device 144 and compared to a signature of the same software that is currently executing. If the signatures match, the executing software may be assumed to be valid and not modified or changed due to a virus or other malware.

An authentication system 142 may authenticate the location information in the form of a token. A token may be a message that may be recognized by the access control system 122 as containing authenticated location information. In some cases, the token may be a cookie, Kerberos ticket, or other type of token.

In many embodiments, the token may be a digitally signed token. In some embodiments, a cryptographic signature or other mechanism may be used to authenticate the token.

Embodiments 300, 400, and 500 presented later in this specification illustrate three different sequences of operations for granting access to a resource. Embodiment 300 illustrates a sequence where a client device communicates with a location authentication server to obtain an authenticated token that contains location information. The token may be passed to the client device, which may forward the token to the resource for evaluation. Embodiment 400 illustrates a similar sequence, except the authenticated token may be passed directly from the location authentication server to the resource without being routed through the client device. Embodiment 500 is yet another sequence where the resource may communicate with the location authentication server without involving the client device to determine the client device location.

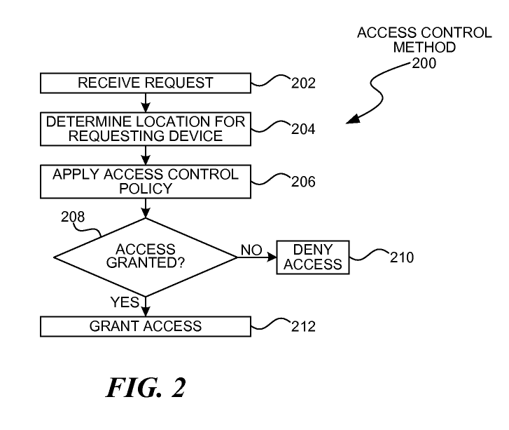

FIG. 2 is a flowchart illustration of an embodiment 200 showing a method for providing access control. Embodiment 200 is a simplified example of a method that may be performed by an access control system, such as the access control system 122 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a simplified example of a method that may be used to grant or deny access to a resource.

A request for access may be received in block 202 and a location for the requesting device may be determined in block 204. The location may be determined by the requesting device itself or may be determined using a third party authentication system, such as a location authentication server, for example.

The access control policy may be applied to the request in block 206. If the policy is not met in block 208, access may be denied in block 210. If the policy is met in block 208, access may be granted in block 212.

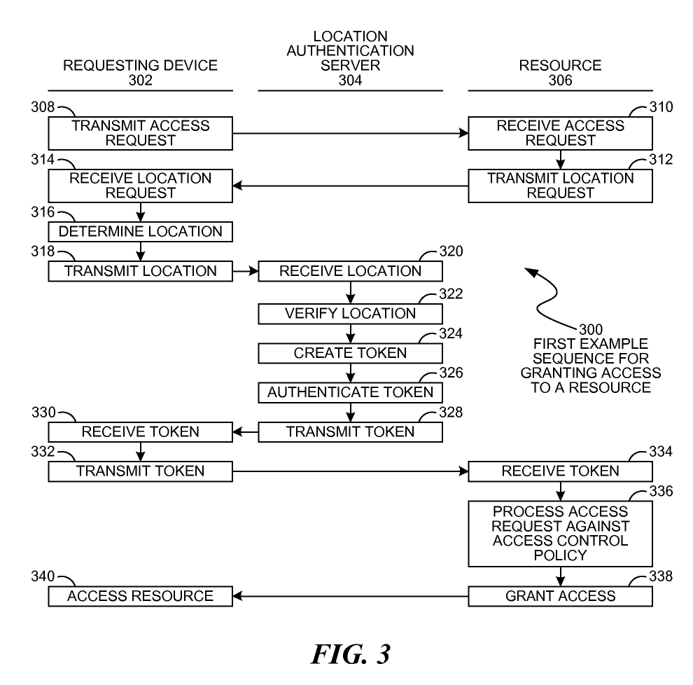

FIG. 3 is a timeline illustration of an embodiment 300 showing a first method for granting access to a resource. The operations of a requesting device 302 are illustrated in the left hand column. Operations of a location authentication server 304 are illustrated in the center column, and operations of a resource 306 are illustrated in the right hand column. The resource 306 may contain an access control system, similar to the access control system 122 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example sequence where the requesting device 302 may communicate with a location authentication server 304 to obtain an authenticated token that verifies the location of the requesting device 302. The authenticated token may be transmitted from the requesting device 302 to the resource 306 to obtain access to the resource 306.

An access request may be transmitted in block 308 from a requesting device 302 to a resource 306. The resource 306 may receive the request in block 310 and transmit a location request in block 312. The location request may be received in block 314 by the requesting device 302.

The requesting device 302 may determine a location in block 316 and transmit the location in block 318 to the location authentication server 304.

The location authentication server 304 may receive the location in block 320, verify the location in block 322, create a token in block 324, authenticate the token in block 326, and transmit the token in block 328 to the requesting device 302.

The requesting device 302 may receive the token in block 330 and transmit the token in block 332 to the resource 306.

The resource 306 may receive the token in block 334, process the token and the request against the access control policy in block 336, and may grant access in block 338. The requesting device 302 may access the resource in block 340.

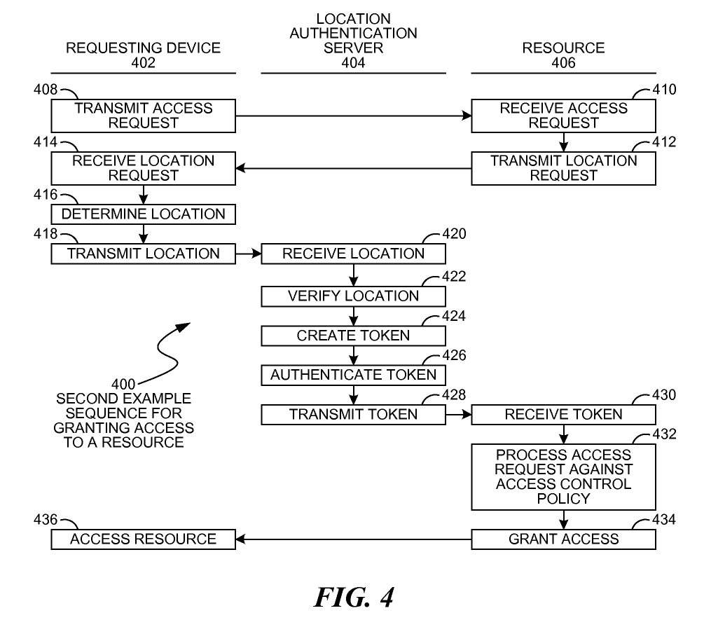

FIG. 4 is a timeline illustration of an embodiment 400 showing a second method for granting access to a resource. The operations of a client device 402 are illustrated in the left hand column. Operations of a location authentication server 404 are illustrated in the center column, and operations of a resource 406 are illustrated in the right hand column. The resource 406 may contain an access control system, similar to the access control system 122 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example sequence where the requesting device 402 may communicate with a location authentication server 404 to obtain an authenticated token that verifies the location of the requesting device 402. Rather than passing the token to the requesting device 402, the authenticated token may be transmitted from the location authentication server 404 to the resource 406 to grant access for the requesting device 402.

An access request may be transmitted in block 408 from a requesting device 402 to a resource 406. The resource 406 may receive the request in block 410 and transmit a location request in block 412. The location request may be received in block 414 by the requesting device 402.

The requesting device 402 may determine a location in block 416 and transmit the location in block 418 to the location authentication server 404.

The location authentication server 404 may receive the location in block 420, verify the location in block 422, create a token in block 424, authenticate the token in block 426, and transmit the token in block 428 to the resource 406.

The resource 406 may receive the token in block 430, process the token and the request against the access control policy in block 432, and may grant access in block 434. The requesting device 402 may access the resource in block 436.

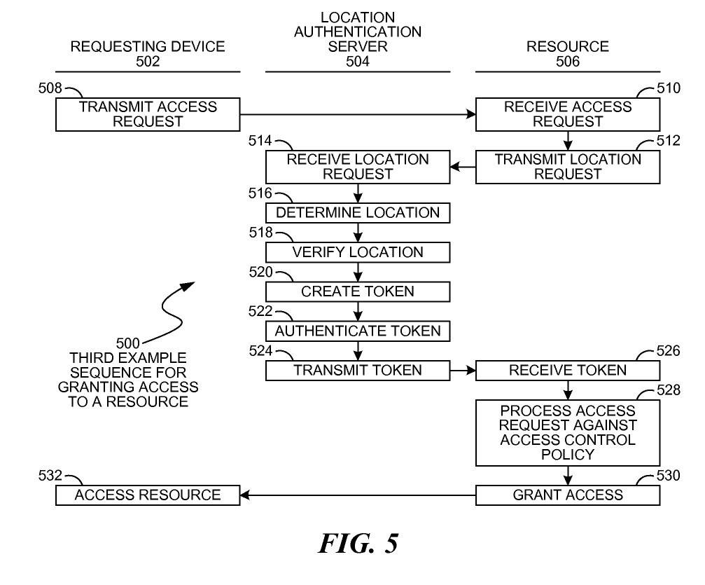

FIG. 5 is a timeline illustration of an embodiment 500 showing a third method for granting access to a resource. The operations of a client device 502 are illustrated in the left hand column. Operations of a location authentication server 504 are illustrated in the center column, and operations of a resource 506 are illustrated in the right hand column. The resource 506 may contain an access control system, similar to the access control system 122 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 is an example sequence where a resource 506 may communicate with a location authentication server 504 to obtain an authenticated token that verifies the location of the requesting device 502. Rather than communicating with the requesting device 502 to obtain location information, the resource 506 may communicate with a location authentication server 504 and may not involve the requesting device 502 in determining location.

An access request may be transmitted in block 508 from a requesting device 502 to a resource 506. The resource 506 may receive the request in block 510 and transmit a location request in block 512. The location request may be received in block 514 by the location authentication server 504.

The location authentication server 504 may determine a location for the requesting device in block 516, verify the location in block 518, create a token in block 520, authenticate the token in block 522, and transmit the token in block 524 to the resource 506.

The resource 506 may receive the token in block 526, process the token and the request against the access control policy in block 528, and may grant access in block 530. The requesting device 502 may access the resource in block 532.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on at least one computer processor, said method comprising:
receiving a first location for a first device and a first request for access to a resource;
applying an access control policy to said first request, said access control policy comprising a set of conditions for permitting access to said resource, at least one of said set of conditions comprising a location parameter;
determining that said first request complies with said access control policy and permitting said first device to access said resource;
receiving a second location for said first device and a second request for access to a resource;
applying said access control policy to said second request;
determining that said second request does not comply with said access control policy and denying said second device to access said resource;

2. The method of claim 1, said first location being an authenticated location.

3. The method of claim 2, said second location being a self-reported location.

4. The method of claim 3, said first location being the same location as said second location.

5. The method of claim 1, said resource being a network resource.

6. The method of claim 1, said resource being a data resource.

7. The method of claim 1, said resource being an application resource.

8. The method of claim 1, said at least one of said set of conditions comprising a proximity to a third location.

9. The method of claim 8, said third location being a predefined location.

10. The method of claim 8, said third location being a location for said resource, said resource being movable.

11. The method of claim 8, said proximity being determined by a maximum distance.

12. A system comprising:
an access control server comprising:
at least one processor;
an access control policy comprising a set of conditions for permitting access to a resource, at least one of said set of conditions comprising a location parameter;
an access control system that:
receives a first request for said resource and a first location for a first device;
applies said access control policy to said first request;
determines that said first request complies with said access control policy, and permits access to said resource for said first device.

13. The system of claim 12 further comprising:
a location authentication server comprising:
at least one processor;
a location processor that:
receives a location authentication request from said first device;
generates an authenticated location token; and
transmits said authenticated location token.

14. The system of claim 13, said authentication location token being transmitted to said first device and received from said first device by said access control system.

15. The system of claim 13, said authentication location token being transmitted to said access control system without being transmitted to said first device.

16. The system of claim 13, said location processor that further:
receives a self-reporting location statement from said first device.

17. The system of claim 16, said location processor that further:
receives a location for said first device from a secondary source.

18. The system of claim 17, said authenticated token being digitally signed by said location authentication server.

19. A method performed on at least one computer processor on a first device, said method comprising:
identifying a resource to access;
determining a location for said first device;
transmitting said location to a location authentication server;
transmitting a request to access said resource, said resource having an access control policy that uses location information to permit or deny access to said resource, said location complying with said access control policy; and
receiving access to said resource.

20. The method of claim 19, further comprising:
receiving an authenticated location token from said location authentication server; and
transmitting said authentication location token to said resource.
